(19) United States
(12) Patent Application Publication
(10) Pub. No.: US 2008/0106090 A1
(43) Pub. Date: May 8, 2008

(54) Method for manufacturing security protective films and associated films for protecting identity documents

(75) Inventors: Andre Pustel, Le Perreux sur Marne (FR); Hugues Souparis, Nogent sur Marne (FR)

Correspondence Address: IP GROUP OF DLA PIPER US LLP, ONE LIBERTY PLACE, 1650 MARKET ST, SUITE 4900, PHILADELPHIA, PA, 19103, US

(73) Assignee: Hologram Industries, a corporation of France, Bussy Saint Georges (FR)

(21) Appl. No.: 11/982,784

(22) Filed: Nov. 5, 2007

(30) Foreign Application Priority Data
Nov. 7, 2006 (FR) FR 0609713

(51) Int. Cl. B42D 15/10; B05C 17/06

(52) U.S. Cl. 283/75; 101/128.21

(57) ABSTRACT

An identity document including a support; and a transparent protective film laminated on the support to seal personal information of the individual, wherein the protective film includes inscription of a first unique identification datum of the film among a plurality of films.

### RELATED APPLICATION

This application claims priority of French Patent Application No. 06/09713, filed Nov. 7, 2006, herein incorporated by reference.

### TECHNICAL FIELD

This disclosure relates to the field of security protective films for protecting identity documents (passports, identity cards, driving licences and the like) and which are used for sealing a page, made of paper, plastic or the like, containing the personal information of the identity document.

### BACKGROUND

It is common to use a transparent protective film that may comprise optical security elements (holograms, for example) to seal personalization information printed on official documents such as passports. The protective films used for this purpose are generally reactivable films having an activable adhesive layer, overlain by a transparent polymer layer serving as a protective layer. Thus, the films are activated during their application on the document to be protected to activate the adhesive property of the adhesive layer. The activation may be created by heating (thermo-activable films) or by radiation (for example, ultraviolet). Such films comprise a certain number of optical security devices (UV printing, diffractive elements, holograms, variable inks, other special printing, etc. widely described such as in US 2004/0239099) with the aim of allowing authentication of the set consisting of a protective film and the document that it is supposed to protect. The component allowing the sealing of information is commonly known as laminate.

The increasingly secured laminates thus represent one of the key obstacles for producing a fake identity document.

In the case of passports, it is understood that they concern any document comprising data sealed by a protective film, and the laminate and the passport are manufactured by different parties. The assembly is typically carried out by the printer who integrates the laminate when assembling all of the pages of the passport into a “stitched laminate” or at the location where the document is edited, personalization via printing of the personal data to be sealed having taken place according to the cases either on the document, or on the laminate before transfer.

The absence of any mark on the latter prevents individual management of the security components creating, among other things, a security flaw in so far as the laminate may be lost, stolen or misappropriated for dubious reasons before being definitively sealed on the document.

WO 2006/071732 discloses an identity document structure comprising a main layer, a coating and a protective laminate. Information of the holder of the document is pre-printed on the main layer. The security coating is partially superimposed with the pre-printed information and represents variable data personalized to the document holder such as an image, a text or digits. The protective laminate is generic, not allowing an individual management.

It could therefore be advantageous to allow such an individual management of the laminates such as to increase the security of the laminated identity documents. It could also be advantageous to secure the laminate and, therefore, the identity documents thus laminated without complicating the process of manufacturing identity documents.

### SUMMARY

We provide an identity document including a support; and a transparent protective film laminated on the support to seal personal information of the individual, wherein the protective film includes inscription of a first unique identification datum of the film among a plurality of films.

We also provide a system for managing a plurality of identity documents including a support; and a transparent protective film laminated on the support to seal personal information of an individual, the protective film including a first identification datum of the film among a plurality of films, the support of the documents further comprising a second unique support identification datum, the system including a first database storing, in a same recording for each document, at least the first protective film identification datum, the personal information and the second support identification datum.

We further provide a method for producing an identity document including a document support and a transparent protective film including inscribing personal information of an individual on the support or the transparent film; and laminating the transparent protective film on the document support to seal the personal information, wherein, during the laminating, the transparent protective film includes a first unique identification datum of the film among a plurality of films.

We still further provide a method for managing a plurality of identity documents including a support and a transparent protective film, the protective film including a first unique identification datum among a plurality of films and the support including a second unique identification datum, including inscribing personal information of an individual on the support or the transparent film; recording, in a first database, the second identification data associated with the personal information; laminating the transparent protective film on the document support to seal the personal information; scanning the laminated document to determine the first and second identification data; and adding into the database, during recording relating to the second identification datum, the first identification datum.

### BRIEF DESCRIPTION OF THE DRAWINGS

The subject matter of our disclosure will also be best understood with the aid of drawings wherein:

FIGS. 1 and 3 show examples of non-laminated protective films;

FIG. 2 shows the structure of a document laminated with the protective film from FIG. 1; and

FIG. 4 is an example of system architecture for managing numbered laminates (protective films).

### DETAILED DESCRIPTION

It will be appreciated that the following description is intended to refer to specific examples of structure selected for illustration in the drawings and is not intended to define or limit the disclosure, other than in the appended claims.

We provide the laminates with identification numbers or other data allowing the unique identification of a laminate among a set of laminates. In particular, we provide a transparent protective film for protecting a surface, the protective film comprising an individualized and indelible inscription of a first unique film identification datum. The inscription is carried out by the laminate supplier.

A simple and individualized management of the laminates is thus made possible, which is akin to a simple management of identifiers. Furthermore, such laminates, if they are lost or stolen, cannot be used easily for producing a fake identity document because the visible number remains easily identifiable. Furthermore, the pair constituting the number and an identifier of the laminated document may constitute a reinforced security key.

Moreover, the usual methods involving laminates do not need to be modified for the use of the laminates. No additional step in the use of the latter is necessary.

The identification data used may be of different types so long as they can be generated in large quantities to ensure a uniqueness of the latter or a quasi-uniqueness (use of a number with x digits, two numbers are repeated every 10^{x} numbers). Wide-spread uni-dimensional bar codes, bi-dimensional bar codes or alphanumeric sequences are particularly suitable.

We also provide an identity document for an individual comprising a support and such a transparent protective film, the protective film being laminated on the support such as to seal the personal information of the individual.

The support is the paper or plastic (PVC—polyvinyl chloride, PET—polyethylene terephtalate, PETF, Polycarbonate and the like) base of documents such as the passport, the identity card, the driving licence or any other document attributed to a person to which a unique identification number is attributed, for example, in the form of a bar code. As in the case of the passport, the personal data, for example, the last name and first name, the date of birth, the nationality, the date of validity, a photo, etc. are printed on the support, either directly, or via the use of intermediate layers. For security reasons, the supports now include optical security elements.

Generally, the protective films comprise a transparent polymer layer on one hand, and also a transparent adhesive layer on the other hand, the latter allowing adhesion of the laminate on the support, for example, via thermo-activation. Optionally, the film is provided with one or more intermediate layers comprising optical security elements.

The identity document thus produced is more secure. Indeed, the process of reconstituting a document or modifying an existing document by a person with bad intentions is more complex: the latter must now acquire a blank protective film of the same type and provide the latter with the appropriate identification data.

Moreover, it is preferable to protect the number of the laminate from an access by a third party who may therefore modify it via chemical or laser methods. It is thus envisaged that the first identification datum is inscribed in mirror image on the face of the protective film adjacent to the support. The face adjacent the support is that which includes the adhesive layer. Thus, the number of the laminate may be inscribed on the adhesive layer via methods suitable for the type of adhesive. Because the face is seen turned over when it is laminated against the support of the document, it is necessary to inscribe the number or the datum inversely (via mirror effect). In this way, when the identity document is laminated, the area inscribed is not directly accessible to a third party. The latter must either detach the laminate or pierce the upper layers (upper polymer layer and possibly the intermediate layers equipped with optical security elements) to access the area. It is therefore easy to detect an alteration of the laminate and, therefore, a potential fake document.

The inscription methods which apply particularly well are, by way of example, printing via ink-jet, thermal marking, laser printing and the like.

Advantageously, in the case of a printing via ink-jet, an ink may be used which penetrates the glue thickness and is “absorbed” by the support when exposed to a stress during the lamination. It is understood by “absorbed” the fact that at least one part of the ink of the film is transferred on the support, the latter absorbing the ink in its structure (paper or plastic). Various stresses may be applied for transferring the ink: heat and/or mechanical transfer or via ultraviolet irradiation or even via infrared irradiation. In particular, it is envisaged that the stress is the same as that used for lamination, allowing the lamination and ink transfer to be carried out at the same time in one single action.

The ink selected may be visible or invisible in the visible spectrum and may be developed under a UV (ultraviolet) or IR (infrared) lamp.

Therefore, an indelible mark of the number is transferred on the paper support and the later installation of a new numbered film therefore becomes complicated due to the necessity of exact positioning and alignment on the old inscription. Furthermore, in the presence of optical security elements, inscription of the number on the protective film must also be exact in consideration of the position of the optical security elements.

An alternative to the printing in mirror image is that the protective film comprises a transparent outer layer, a transparent adhesive layer suitable for being applied on the support, and a metallic surface representing a portion of the surface of the protective film, the metallic surface being disposed between the outer layer and the adhesive layer, and the first identification datum is engraved into the metallic surface. The engraving is produced, for example, via laser marking. The metallic surface may also comprise optical security elements such as a hologram aiming to complicate reproduction of the latter.

Moreover, it is envisaged that the first identification datum further comprises checksums of the bar code or alphanumeric sequence. For example, the number inscribed on the film is completed with a plurality of check digits calculated according to known methods, for example, according to a hash function (for example, SHA-256), a parity bit checksum via redundancy or cyclic redundancy (CRC). The presence of such data complicates generation of coherent identification data and allows a first local verification of the coherence.

We also provide a set of protective films comprising a unique base having a plurality of protective films, each one of the protective films comprising the inscription of a first unique film identification datum. The protective films may be disposed on the base, for example, by means of a slightly adhesive layer. The protective films may also be produced from a single part with the base and are not yet cut out.

The set of protective films may be presented in the form of a wound reel, in the form of large sheets comprising a plurality of films or in other independent formats.

The set may be produced by the laminate manufacturer and easy to use for the personalization center or printer.

Optionally, the first identification data are generated randomly for the plurality of protective films. Therefore, the distribution of a number (or bar code) does not provide information on the other numbers also distributed via the same reel or via the same set.

To simplify management of the identification data, the first identification datum may comprise an alphanumeric sequence(s) and the alphanumeric sequence(s) are generated sequentially for the plurality of protective films, for example, via simple incrementation.

To simplify identification of protective films in the set, it is possible to equip the set with marks. Holographic images present in the structure may be used as marks when the same pattern is applied to the same location for each of the protective films. When the set is continuous, i.e., that a pattern is repeated throughout without providing information of any position of the protective film, it is envisaged to provide a regular marking on the set (reel), for example, via a printing of a mark, a pre-cut out or an identifiable symbol.

In the past, verification of passports at a customs post has been restricted to verifying that the photo is that of the holder and that the data printed corresponds to the passport number in a central database. The systems do not allow, during verifications, new data inserted into the laminates to be taken into account. We thus provide a system for managing a plurality of identity documents for individuals comprising a support and a transparent protective film laminated on the support such as to seal the personal information of the individual, the protective film comprising a first identification datum, the supports of the documents further comprising a second unique support identification datum, for example, the number of the passport, the system comprising a first database, “the central database,” storing, in the same recording for each document, at least the first protective film identification datum, the personal information and the second support identification datum. The recordings are accessible by the customs officers without modification of their interface and only require a small adjustment of the already existing databases to add there a field dedicated to the number of the laminate. In this way, the checks at customs posts may be more complete.

Filling out this database, in particular the activation of the laminate number and its association with the data of the passport, is carried out during a step for controlling the quality of the identity document, just before issue. Various mechanisms allow the laminate number to be activated, for example, automatically due the single fact that the number is present in the database and thus used, or specifically by completing a dedicated field (a flag, for example) when an effective activation is desired, for example, when the identity document is handed over to its holder.

It seems desirable to provide an additional check on the laminate numbers available at the time of the checking step so not to validate an incorrectly input or incorrectly identified number. To this end, it is envisaged that the system further comprises a second database storing the first identification data of the protective films and comprising, for each of the identification data, a status indicator taking a first value when the first identification datum is associated with a second identification datum in a recording of the first database and taking a second value when the first identification datum is not present in the first database.

The second database is supplied by the laminate supplier who, during manufacturing of the latter, provides information on the numbers of the laminates produced and delivered for distribution. In the base, the numbers are identified as good for the production (first value of the status indicator), i.e., the corresponding laminate is available to be applied to an identity document, then are identified as used (second value of the indicator) when they appear in the central database, i.e., the corresponding laminate has been used for laminating an identity document. Consultation of the second database allows the availability of a number to be validated before its use and placing in use of the passport or corresponding document.

The second database may be easily produced in the form of an electronic file containing the available numbers.

The checking step is generally carried out by an automatic scanner which reads the information and data of the identity documents. It is thus envisaged that the system further comprises means for scanning the identity documents, the scanning means being arranged for determining the first identification datum of the protective film and the second identification datum of the support and for associating, in the first database, the first identification datum of the protective film with a recording comprising the second identification datum of the support. Optionally, the scanner also verifies the accuracy of the personal information completed in the database in relation to that scanned.

We also provide methods for manufacturing, by the laminate supplier, transparent protective films of a surface comprising a step for generating a first unique identification datum and a step for associating the first identification datum with the protective film via inscription of the first identification datum on one of the faces of the film. The aforementioned transparent film is thus obtained.

Our methods distance themselves from known methods because no inscription of an identification datum is produced on the known laminates. The latter are used blank, as illustrated in the aforementioned WO 2006/071732.

Our methods have the advantage of remaining simple while providing an additional degree of security for such laminates.

According to various aspects:
the first identification data are generated randomly;
the first identification datum comprises an alphanumeric sequence, the sequence being generated sequentially;
the system comprises generation of a plurality of first identification data and a step for inscribing the plurality of first identification data on a transparent base having a plurality of protective films. In particular, a protective film comprises a portion of the base comprising one among the first identification data inscribed;
the base comprises regular markings defining the dimensions (limits) of the protective films, and the first identification data are inscribed at a position defined in relation to the markings.

The protective film may be equipped with an activable adhesive layer and the inscription is, therefore, produced inversely (mirror effect) on the adhesive layer.

In one alternative, the protective film, or even the base from which the film originates, comprises a metallic surface disposed between the activable adhesive layer and the outer protective layer, the film identification datum being engraved into the metallic surface.

It is understood that preliminary steps for constituting the transparent film may be envisaged, in particular, for developing a multiple-layer structure equipped with security elements such as aforementioned.

We further provide methods for manufacturing an identity document for an individual comprising a document support and a transparent protective film, the methods comprising a step for inscribing personal information of the individual (on the support or the transparent film) and a step for laminating the transparent protective film on the document support such as to seal the personal information, the transparent protective film comprising, during the laminating step, a first unique film identification datum. Our methods thus differ in that now, as a laminate, a protective film equipped with an identification number or equivalent, is applied.

The aforementioned security advantages are thus provided by the method. The traditional methods are only modified a little and are based on the same laminating, printing, etc., machines.

According to various aspects:
the method further comprises a step for inscribing in mirror image the first identification datum on the face of the protective film adjacent to the support;
the inscription is a printing by ink-jet;
the inscription is a thermo-printing;
the method further comprises a step for laser engraving the first identification datum on a metallic surface representing a portion of the surface of the protective film, the protective film comprising a transparent outer layer and a transparent adhesive layer suitable for being applied on the support, the metallic surface being disposed between the outer layer and the adhesive layer of the film.

Referring to the aforementioned management system, we also provide methods for managing a plurality of identity documents for individuals comprising a support and a transparent protective film, the protective film comprising a first unique identification datum and the support comprising a second unique identification datum, the method comprising:
a preliminary step for inscribing personal information of the individual (on the support or the transparent film) and a step for recording, in a first database, the second identification data associated with the personal information;
a step for laminating the transparent protective film on the document support such as to seal the personal information;
a step for scanning the laminated document for determining the first and second identification data;
a step for adding, into the database, during the recording relating to the second identification datum, the first identification datum.

It is also envisaged a later step for checking, for example, at customs, an identity document comprising verification in the first database of the existence of a recording comprising the first and second identification data of the document checked.

The addition step may simply consist of filling out, with the identification number of the laminate read by the scanner, a field left blank by the administration in the recording relating to the data of the passport or document. The step thus remains simple and only requires slight adjustment of the already existing databases and control software of the latter.

Finally, the later check is carried out when the document is used by the individual, for example, at customs. The additional verification is simple and includes checking the existence of a recording associating the laminate number with the passport number.

Thus, during a check, a simple verification of the correspondence of the number of the passport with the number of the laminate allows, via a simplified interrogation of the central database, the legitimacy of the components of the passport to be verified. The method has the advantage of adding an important functional security without adding steps to the process of developing and issuing passports.

Moreover, it is also envisaged that the method further comprises:
a step for inscribing the first identification datum on the protective film;
a step for recording the first identification datum inscribed in a second database (or an electronic file) and for associating a status indicator taking value among at least one first (“good for the production”) and a second value (“used”) with the first identification datum recorded, the indicator initially taking the first value; and
during the addition step, a step for modifying the value of the indicator with the second value, indicating in this way that the laminate number used is no longer available for a subsequent document.

The subject matter of this disclosure applies notably to any security laminate used for the production of sensitive documents such as passports or other identity document.

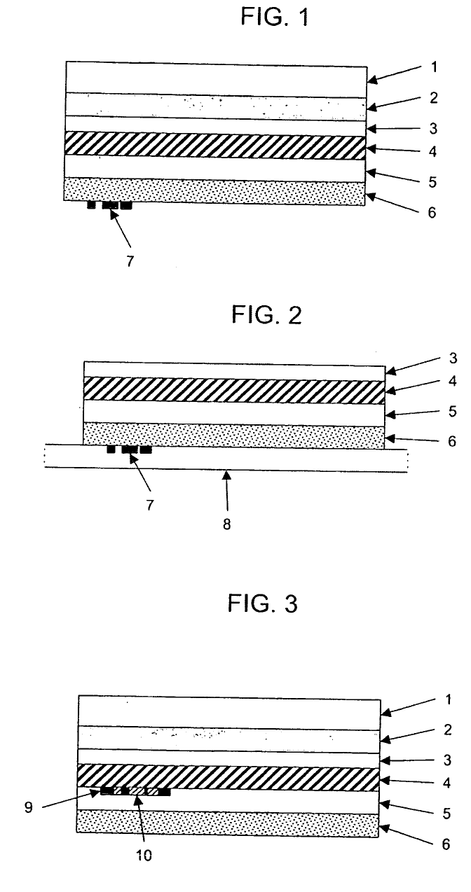

Referring to FIG. 1, a numbered protective film is manufactured from a holographic lamination film comprising:
a polyester carrier film 1 with a thickness included between about 10 and about 50 μm;
a detachment layer 2 which is equivalent to a wax;
one or more protective layers 3. The layer is the outer layer of the product after lamination. It may, therefore, comprise a plurality of layers having mechanical and chemical resistance properties. The layer is transparent;
an embossing layer 4, for example, a thermo-formable layer.

Embossing of the last layer 4 is carried out to form by exposure to heat microstructured areas constituting the optical security elements.

Then follows a vacuum deposition, on the free surface of the embossed layer 4, of a layer of a transparent material having a high optical refractive index 5, for example, a transparent dielectric material, in particular, ZnS or the like. The layer also constitutes an optical and holographic security element.

Then, the coating is carried out of the lower surface of the refractive layer 5 via a heat reactivable adhesive layer 6. Individual personalization of the laminates is carried out via printing of a number 7 on the lower surface of the adhesive layer. Printing is produced in mirror image.

The adhesive layer is transparent either by nature or after thermal activation or equivalent, i.e., once laminated, the layer is transparent to allow vision via the upperside of the protective film of the number 7 printed.

Finally, finishings are carried out, typically the manufacturing of bobbins/reels or of the components to be inserted into the passport. Optionally, the personalization may take place before or after the finishings.

FIG. 2 shows a document 8 laminated with the aforementioned protective film. To this end, the personalized and finished film (see FIG. 1) is placed on the substrate 8 of the document to be laminated, adhesive face on the document. A thermal activation of the adhesive layer 6 allows sealing, on the document 8, the information printed on the document along with the laminate number 7. The polyester carrier 1, allowing easy handling and protection of the film before application, is removed with the aid of the detachment layer 2. The remaining layers are transparent to allow reading through of the number 7 printed in mirror image and, therefore, read the right way round.

After lamination, only the layers 3 to 7 are thus transferred on the document to be protected.

Another film is shown in FIG. 3. The manufacturing starts from the same holographic lamination film comprising the aforementioned layers 1 to 4. After the embossing step, a vacuum deposition, on the free face of the embossed layer 4, of aluminium or other metal 9, is carried out. The deposition may be localized on one portion only of the embossed layer. Stripping is carried out on the totality of the areas of the film that must remain transparent to allow only the desired inscriptions 10 to remain. Numerous stripping methods are known and may be used.

Then follows a step for depositing a refractive layer 5 then an adhesive layer 6 coating as above-mentioned.

The step for individual personalization of the laminates is carried out via laser marking in the metallic layer a number, for example, via local destruction of the layer.

The finishings are applied in the same manner as aforementioned.

The protective film thus produced is applied in the similar manner as that described in relation to FIG. 2.

Various characteristics of the numbering of the laminate are as follows:
sequential or random numbering using either alphanumeric codes (OCR font), or optionally secured 1D or 2D bar codes. The number may be a sequential or more sophisticated serial number with one or more check digits (hash function, checksum) or the like.
a thermal marking, by ink-jet, laser or other.
the positioning of the number may be carried out at a preferred location, below the photo (as indicated in the diagram).
an indelible/indestructible numbering. In particular, the printing (in mirror image) on the inner face of the laminate allows that the number after sealing of the laminate on the passport finds itself trapped under the laminate. Any attempt of adulteration of the number therefore results in the local destruction of the passport at the location of the number.

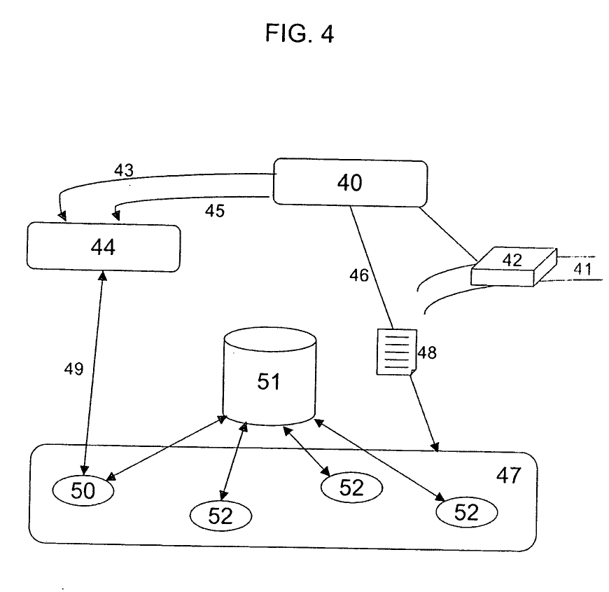

Referring to FIG. 4, the laminate manufacturer 40 produces the printing of the laminate numbers on the adhesive back of the reel 41 of protective films by means of a printer 42.

The manufacturer 40, therefore, transfers 43 the reel of numbered laminates to the printer 44 who will laminate the films on the official documents to be sealed. A transfer of the numbers produced corresponding to the numbers supported by the laminates is also produced 45 either by means of a database completed by the manufacturer 40 or by means of a dedicated digital file.

If necessary, the laminate manufacturer 40 may transmit in a secured manner 46 to an end customer 47 (not the printer, but in general the government department responsible for issuing passports), a file 48 containing all of the codes issued.

The printer 44 then transmits 49 the laminated documents to the end customer 47.

Activation of the code (laminate number) is carried out automatically during quality control of the passport by the government department responsible for issuing passports 50. Control is carried out automatically via digitalization of the document in a known manner.

It is already known to carry out the following operations via a scanning machine:
scanning the surface to verify the presence and the quality of U.V. and I.R. printings (optional).
scanning the MRZ (machine readable zone) zone to verify legibility of the area and check coherence of the information read with the personal data of the holder of the passport. In particular, it is verified that the check characters are correct.
recording, in the central database 51, that the check has been carried out correctly and change of status of the booklet in the process for issuing the document.

It is possible to carry out the following additional operations:
reading the code of the laminate (1D bar code font code 128 or 3 among 9 with clear number inscribed below the code, possibility of producing a more sophisticated encoding with 2D bar code) via the scanning device already equipping the competent department 50.
possible verification of the legitimacy of the code read. For example, the presence of the number read is verified among those issued from the stock and declared good for the production in the file transmitted 48, and possibly a coherence check is carried out if the code comprises hash data or a checksum.
recording of the laminate code, in the central database 51, concurrently with the information already stored concerning the booklet and the individual with whom it is associated.

The additional operations only require a minor adaptation of the already existing management software and operation is thus completely transparent on the place of issue of the passport.

When operational, the laminate number constitutes an additional security for the official documents (passports) and a check of the passport is therefore carried out by the dedicated entities 52, for example, customs. The following steps are carried out during verification:
physical existence of the number on the passport, possibly at the location for which it is reserved; and
reading and check with the central database 52 to verify correspondence of the various elements of the passport: the database may go back to the data associated with the laminate number and with the passport number to verify accuracy with the personal inscriptions of the holder sealed on the document.

1. An identity document comprising:
a support: and
a transparent protective film laminated on the support to seal personal information of the individual, wherein the protective film comprises inscription of a first unique identification datum of the film among a plurality of films.

2. The document according to claim 1, wherein said first identification datum is inscribed in mirror image on a face of the protective film adjacent to the support.

3. The document according to claim 2, wherein said first identification datum is printed by ink jet on the adjacent face.

4. The document according to claim 2, wherein said first identification datum is thermo-printed on the adjacent face.

5. The document according to claim 2, wherein the protective film comprises a transparent outer layer and a transparent adhesive layer applied on the support, the adhesive layer constituting an adjacent face on which is inscribed the first identification datum.

6. The document according to claim 3, wherein the adhesive layer is thermo-activable and the ink is partially transferred on the support when exposed to heat.

7. The document according to claim 1, wherein the protective film comprises a transparent outer layer, a transparent adhesive layer applied on the support, and a metallic surface representing a portion of the surface of the protective film, the metallic surface being disposed between the outer layer and the adhesive layer, and the first identification datum is engraved into the metallic surface.

8. The document according to claim 1, wherein the first identification datum comprises at least one feature among a mono-dimensional bar code, a bi-dimensional bar code and an alphanumeric sequence.

9. The document according to claim 1, wherein the protective film comprises optical security elements.

10. A system for managing a plurality of identity documents comprising:
a support; and
a transparent protective film laminated on the support to seal personal information of an individual, the protective film comprising a first identification datum of the film among a plurality of films, the support of the documents further comprising a second unique support identification datum, the system comprising a first database storing, in a same recording for each document, at least the first protective film identification datum, the personal information and the second support identification datum.

11. The system according to claim 10, further comprising a second database storing the first identification data of the protective films and comprising, for each one of the identification data, a status indicator taking a first value when the first identification datum is associated with a second identification datum in a recording of the first database and taking a second value when said first identification datum is not present in the first database.

12. The system according to claim 10, further comprising scanning means for the identity documents, the scanning means determining the first identification datum of the protective film and the second identification datum of the support and associating, in the first database, the first identification datum of the protective film with a recording comprising the second identification datum of the support.

13. A method for producing an identity document comprising a document support and a transparent protective film comprising:
inscribing personal information of an individual on the support or the transparent film; and
laminating the transparent protective film on the document support to seal the personal information,
wherein, during the laminating, the transparent protective film comprises a first unique identification datum of the film among a plurality of films.

14. The method according to claim 13, further comprising inscribing in mirror image the first identification datum on the protective film adjacent to the support.

15. The method according to claim 14, wherein the inscription is printing by ink-jet.

16. The method according to claim 14, wherein the inscription is thermo-printing.

17. The method according to claim 14, further comprising laser engraving the first identification datum on a metallic surface representing a portion of a surface of the protective film, the protective film comprising a transparent outer layer and a transparent adhesive layer applied on the support, the metallic surface disposed between the outer layer and the adhesive layer of the film.

18. The method according to claim 13, comprising preliminarily generating the first unique identification datum and associating the first identification datum with the protective film via inscription of the first identification datum on one of the faces of the film.

19. The method according to claim 18, wherein the first identification data are generated sequentially.

20. The method according to claim 18, comprising generation of a plurality of first identification data and inscribing the plurality of first identification data on a transparent base having a plurality of protective films, each transparent film being made of a portion of the base comprising one among the first identification data inscribed.

21. A method for managing a plurality of identity documents comprising a support and a transparent protective film, the protective film comprising a first unique identification datum among a plurality of films and the support comprising a second unique identification datum, comprising:
inscribing personal information of an individual on the support or the transparent film;
recording, in a first database, the second identification data associated with the personal information;
laminating the transparent protective film on the document support to seal the personal information;
scanning the laminated document to determine the first and second identification data; and
adding into the database, during recording relating to the second identification datum, the first identification datum.

22. The method according to claim 21, further comprising checking an identity document comprising the verification in the first database of the existence of a recording comprising the first and second identification data of the document checked.

23. The method according to claim 21, further comprising:
inscribing the first identification datum on the protective film;
recording the first identification datum inscribed in a second database and associating a status indicator taking value among at least one first and one second value with the first identification datum recorded, the indicator initially taking the first value; and
during addition, modifying the value of the indicator with the second value.
